(19) United States
(12) Patent Application Publication
(10) Pub. No.: US 2020/0076260 A1
(43) Pub. Date: Mar. 5, 2020

(54) Machine coil for an electric machine

(71) Applicant: Oswald Elektromotoren GmbH, Miltenberg (DE)

(72) Inventors: Johannes Oswald, Miltenberg (DE); Bernhard Oswald, Miltenberg (DE); Alphons Theophile Augusta Maria de Waele, Veldhoven (NL)

(21) Appl. No.: 16/535,114

(22) Filed: Aug. 8, 2019

(30) Foreign Application Priority Data
Aug. 8, 2018 (DE) 10 2018 119 291.6

(51) Int. Cl. H02K 3/24; H02K 3/02

(52) U.S. Cl. CPC H02K 3/24; H01F 6/04; H02K 3/02

(57) ABSTRACT

A machine coil (1) for an electric machine (16) comprises at least one winding (3). The winding (3) comprises multiple winding layers (4), arranged respectively adjacent to one another and connected with one another in an electrically conductive manner, made of an electrical conductor. A heat conductor (6) is arranged between two winding layers (4) arranged adjacent to one another and is connected with at least one winding layer (4) in a heat-exchanging manner. At least one section (7) of the heat conductor projects out of the winding (3). A cooling pipe, connectable with a cooler, is arranged on the section (7) and connected with the section (7) in a heat-exchanging manner.

### TECHNICAL FIELD

The disclosure relates to a machine coil for an electric machine, wherein the machine coil comprises at least one winding, and wherein the winding comprises multiple winding layers, arranged respectively adjacent to one another and connected with one another in an electrically conductive manner, made of an electrical conductor.

### BACKGROUND

Such machine coils constitute an essential part of electrical machines. Usually, machine coils comprise at least one winding of a conductor, for example a wire, which is for example wound up around a winding axis on a suitable bobbin. The conductor can be arranged around the winding axis in one turn or in multiple turns per winding layer. A winding layer is characterized in that the turns of a winding layer respectively have the same distance to the winding axis. All turns are usually configured electrically insulated to one another, in order to avoid a so-called shorted coil.

Along with the windings which conduct an electrical current, machine coils comprise an element, usually referred to as iron core, made of a material which can well conduct the magnetic flux caused by the current flow through the winding. A soft-magnetic material is frequently used as core material. The electrical and magnetic features of the machine coil are defined by the respectively used turn arrangement and turn type of the winding, the wire diameter, the winding- and the core material.

Machine coils are employed in different electric machines, for example direct current machines, transformers, asynchronous machines, synchronous machines and single-phase alternating-current machines. The number of winding layers, the electrically conductive material of the electrical conductor used, the geometric arrangement of the windings and the arrangement and configuration of the iron core differ from one another depending on the application purpose. Designs of machine coils suitable for the most different intended uses are known from the prior art.

It is also known from the prior art that, depending on the intended use, the machine coils must be appropriately cooled, for example in order to dissipate current heat losses inside the windings. A cooling, in particular of the windings, is compulsorily also in electrical machines whose windings consist of superconducting materials. Windings of superconducting materials must be cooled to below a material-specific transition temperature. If the temperature of the superconducting materials falls below this transition temperature, its electrical resistance drops abruptly to nearly zero so that, in particular in the application of an alternating current to the windings, only a low energy loss occurs.

Different cooling concepts for cooling the windings are known from the prior art. Cooling the windings directly via a corresponding refrigerant is known, for example.

In the known electrical machines with superconducting windings, the windings are usually cooled by bath cryostats, in which the machine coils to be cooled are surrounded by a cryogenic liquid, for example by liquid nitrogen, or cooled by a refrigerator cryostat, in which the cooling occurs through a so-called cryo-cooler. In the known coolers, it is required that the components of the cooler arranged in the region of the windings, for example the bath cryostats, are produced of an electrically non-conducting material, in order to avoid an induction of eddy currents in the components. The conventional connection technology for further components of the cooler, for example of the heat exchanger is, by contrast, usually configured from metal. In particular due to the different heat expansion characteristics of the different materials used, it is extremely elaborate, in the known machines, to provide liquid and gas-tight transitions and to avoid an undesired leakage of the cryo-liquid.

### SUMMARY

The object of the disclosure is to improve the machine coils known from the prior art such that an as simple as possible cooling of the windings of the machine coils is achieved.

This object is achieved in that a heat conductor is arranged between two winding layers arranged adjacently to one another, and is connected with at least one winding layer in a heat-exchanging manner, wherein at least one section of the heat conductor proj ects out of the winding, and wherein, on one section, a cooling pipe connectable to a cooler is arranged and is connected with the section in a heat-exchanging manner. Advantageously, the machine coil comprises a bobbin and/or an iron core.

The heat conductor is advantageously produced of a heat-conducting material, for example copper. Via the heat conductor, the heat arising in the winding is discharged from the winding and, via the cooling pipe resting against the section, guided out of the electric machine. Advantageously, the cooling pipe exclusively rests against the section here, so that the cooling of the windings occurs at least substantially via the heat conductor, the section and the cooling pipe arranged on the section. The cooling pipe is advantageously connected with the section via welding, soldering or adhesion.

The heat conductor is advantageously a metal sheet, which is arranged between two winding layers of the winding, and partially projects out of the winding. The dimensions of the heat conductor or metal sheet used should be selected such that an as good as possible thermal connection of the winding or of the winding layers directly adjacent to the heat conductor can be achieved. Advantageously, the dimensions of the heat conductor are selected such that the heat conductor, with its entire surface, rests against the winding layers arranged adjacent to one another.

Advantageously, the heat conductor almost completely covers the winding layer. The winding process is in this configuration interrupted before the introduction of the heat conductor, and the conductor is initially separated. Subsequently, the heat conductor is arranged on the outermost winding layer, and the winding process again taken up anew. In this configuration, winding layers, separated via the heat conductor, are advantageously connected with one another at transition points in an electrically conductive manner, via a suitable conductor.

It is, however, also possible and provided that the heat conductor does not completely cover the winding layer, but merely rests against the winding layer in sections. In this configuration, the heat conductor can advantageously be wound up into the winding in a winding process.

In order to achieve a higher cooling performance of the winding, it is provided that the machine coil comprises multiple heat conductors, wherein respectively one heat conductor is arranged respectively between two winding layers arranged adjacently to each other.

Here, the heat conductors are advantageously arranged at a pre-specified distance to one another, between respectively two winding layers, so that the heat exiting from a winding section of the winding formed by winding layers arranged between two heat conductors is discharged by each heat conductor. Here, each winding section comprises multiple winding layers, and is delimited from the next winding section or a surrounding of the winding, via at least one heat conductor.

It is advantageously provided that the electrical conductor is produced of a super-conductive electrical material. High-temperature superconductors, for example, may be considered as superconductive material, the transition temperature of which conductors can already be reached at a temperature of minus 140 degrees Celsius. Superconductive materials, for example in strip or wire form, can be employed for the winding of the machine coils. Among others, the compositions YBCO 10 (YBCO coated conductor), BSCCO, MgB2 or Pnictide come into consideration as superconducting materials, which can have an extraordinarily high current density in sufficiently low temperatures.

In a particularly advantageous configuration of the machine coil, it is provided that the cooling pipe rests against the section. The cooling pipe is advantageously likewise produced from a material with good thermal conductivity, for example copper, through through which a heat carrier medium, for example water, flows.

It is advantageously provided that the heat conductor and the cooling pipe are produced from a metallic material. The metallic material preferably is copper, cupronickel, nickel silver or stainless steel. Through the use of the metallic material, the heat conductor can be thermally well-connected to the winding, and the cooling pipe and the heat conductor can simply be connected with one another, for example through a solder connection, which also offers a sufficient strength and sealing effect, also at cryogenic temperatures required for the cooling of superconductive windings below the transition temperature. In addition, heat conductors and cooling pipes of metal have a heat expansion similar to that of superconductive materials, so that the heat conductors can simply be placed on the winding layers and a contact between the winding layers and the heat conductor sufficient for the required heat transport is achieved. In addition, the metallic materials conduct heat well, so that a good thermal connection to the winding can be achieved through metallic heat conductors and cooling pipes.

In order to be able to cool superconductive windings to below the transition temperatures, it is provided that a cryogenic fluid flows through the cooling pipe. The cooling pipes are designed sufficiently pressure-resistant and are produced from a material which is suited to the transport of cryogenic cooling liquids or refrigerants, for example helium, hydrogen, neon, nitrogen or the like.

In order to avoid eddy-current losses arising in the cooling pipes to the greatest possible extent, the cooling pipes have an outer diameter of between 0.3 mm and 1.5 mm. The cooling pipes furthermore have a wall thickness of maximally 10% of the outer diameter. The wall thickness advantageously lies between 0.03 mm and 0.15 mm. In this way, merely an extremely small eddy current is induced in the cooling pipe.

In the use of heat conductors for cooling the winding, the cooling capacity is transferred to a wall of the cooling pipe and to the cooling liquid flowing through the cooling pipe, in particular by convection, via the heat conductor. In using a cryogenic fluid within the cooling pipe, a phase transition of the cooling liquid from liquid to vapor-form can also be made use of for heat dissipation, so that merely a low inflow speed of the cooling liquid into the cooling pipe of, for example, 1 to 2 m/s is required. It is, however, also possible and provided that the heat dissipation occurs without phase transition, wherein, advantageously, higher inflow speeds of, for example, 10 to 20 m/s can be used.

It is advantageously provided that the heat conductor comprises at least one electrical insulation layer arranged between at least one winding layer adjacent to the heat conductor and the heat conductor. In this way, the windings can for example be applied with an alternating electric current, while no or merely a small current flows via the heat conductor and the cooling pipe.

It is, however, also possible and provided that the heat conductor is electrically-conductively connected with at least one winding layer adjacent to the heat conductor. In this way, the heat conductor, if necessary, the cooling pipe and the winding layer electrically conductively connected with the heat conductor are at the same potential, so that an electrical current flows via the heat conductor and, if necessary, also the cooling pipe.

In particular in an applying of alternating current to the winding and a conductive connection between the heat conductor and at least one winding layer, it is provided that the cooling pipe comprises an electrically insulating section arranged distanced to the winding. In this way, a current flow to further integral parts of the electric machine, for example a refrigeration machine connected with the cooling pipe, can be avoided.

In a particularly advantageous configuration of the machine coil, it is provided that the heat conductor comprises at least one interruption section, in which the heat conductor is completely interrupted, so that no closed conductor loop is formed by the heat conductor resting on the winding layer. In this way, a current flow induced in the heat conductor can be reduced, in particular in use of the machine coil with alternating currents, whereby a dissipation loss brought about through the induction is lessened in the heat conductor.

It is advantageously provided that the winding is configured toroidally and that the winding is produced of a strip-shaped electrical conductor material. Through the use of strip-shaped electrical conductors or of flat conductors, the different winding layers, if necessary, electrically and thermally shielded from each other, can be arranged with a maximum contact area to the heat conductors, in order to achieve an as good as possible thermal connection to the heat conductor. It is advantageously also provided here that the heat conductor is likewise produced from a flat conductor or a strip-shaped material. In a machine coil with a winding from a strip-shaped conductor, the winding layers advantageously each comprise one single turn.

Advantageously, the heat conductor is oriented in the same direction as the winding. This is in particular possible through usage of strip-shaped conductors and heat conductors. Since the heat conductors are no integral part of the winding and can be configured electrically insulated at least with respect to further components of the electric machine, a good shielding of magnetic flux components can in addition be achieved by means of the heat conductors, which flux components arise between winding layers or winding sections of a winding. Since the heat conductors proj ect in sections out of winding and at the same time advantageously rest against the entire winding surface of a winding layer, the heat conductors in addition have a greater width than the winding layer. The shielding effect is hereby further enhanced.

The disclosure also relates to an electric machine with a stator, with a rotor and with multiple machine coils having windings made of a superconducting electrical conductor, which are configured as described above, wherein the windings are respectively arranged in a thermal insulator, and wherein the electrical machine comprises a cooler connected with the cooling pipe in a heat-conducting manner. The electric machine having a superconductive winding can be operated with a three-phase alternating current, for example. It is also possible, however, to operate the electric machine with a higher-phased alternating current. Here, the electric machine can be operated in a low speed range and simultaneously high torque, as well as in a so-called field-weakening range, up to high speeds with a constant power output.

The electric machine can be a rotating electric machine. The machine coils can be arranged on or in the rotor, as well as on or in the stator. The stator can be arranged outside (as an outrunner) or inside the rotor (as an inrunner).

In order to reduce the cooling capacity necessary for the cooling, it is provided that the winding to be cooled and the cooling pipe are arranged inside a thermal insulator. The thermal insulator can be a radiation-shielding film or another reflecting surface, for example.

It is moreover possible and provided that the thermal insulator comprises regions, in which a vacuum can be generated. In this case, it is required that the winding to be cooled, the heat conductor and the cooling pipe are separated from the thermal insulator in a vacuum-sealed manner. It is also possible that a vacuum prevails in the entire thermal insulator.

In order to reduce the eddy currents generated in the thermal insulator by the alternating field caused by the machine coils, it is provided according to the invention that the thermal insulator consists of a material which has a high electrical resistance. The thermal insulator can consist of a plastic material with correspondingly high electrical resistance, for example.

In a particularly advantageous configuration, it is provided that the cooling pipe is fillable with a cryogenic fluid. The cryogenic fluid can be a cryogenic liquid or a cooled gas. Liquid nitrogen, liquid neon, liquid hydrogen or liquid helium, for example, come into consideration as cryogenic liquid.

It is provided that the cooler comprises a cryocooler. The cryocooler is a suitable heat exchanger which dissipates heat taken up by the cryo-fluid. In this case, the components of the cooler expediently constitute a closed circuit, which is formed by corresponding hose or pipe connections arranged between the cryocooler and the cooling pipes. To circulate the cryo-fluid within the closed cooling circuit, a corresponding coolant pump can be provided. It is, however, also possible to operate the cooler in an open cooling circuit.

Advantageously, it is provided that the cooler comprises a regulating device, which is suited to adaptively adjust a cooling capacity to a machine load. In this way, higher machine loads arising in short-term can, for example, also be accommodated by the electric machine, without the temperature of the windings reaching the transition temperature and the windings losing the superconductive property. The regulating device can, for example, comprise a regulating valve arranged in the cooling circuit, a temperature sensor in the return of the cooling circuit and a digital-electronic processing device, wherein the regulating device is adapted to a regulating of the measured return temperature with the regulating valve.

In a particularly advantageous configuration, it is provided that the electric machine comprises a controllable or regulatable supply device to control or regulate a machine speed. The controllable or regulatable supply device can relate, for example, to a frequency converter.

Further advantageous configurations of the inventive idea are explained in the drawings based on exemplary embodiments.

### BRIEF DESCRIPTION OF THE DRAWINGS

FIG. 1 is a schematically illustrated plan view onto a machine coil.

FIG. 2 a schematically illustrated sectional view of the machine coil represented in FIG. 1 along the section line I-I.

FIG. 3 a schematically illustrated sectional view of an alternatively configured machine coil.

FIG. 4 is a schematically illustrated view of an electric machine.

### DETAILED DESCRIPTION

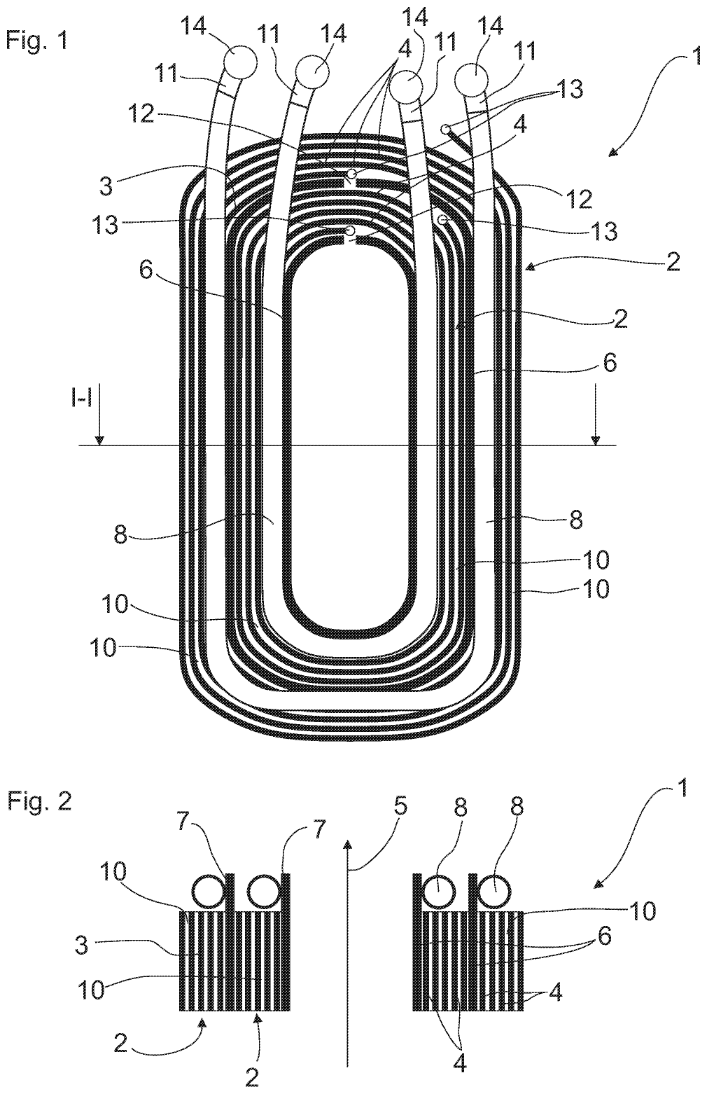

FIG. 1 schematically illustrates a plan view onto a machine coil 1, and FIG. 2 a sectional view of the machine coil 1 along the sectional line I-I. The machine coil 1 comprises a winding 3 including multiple winding sections 2. The winding 3 or the winding sections 2 comprise multiple winding layers 4, arranged adjacent to each other and connected with one another in an electrically conductive manner, made of an electrical conductor. Individual winding layers 4 are exemplarily denoted in the illustration by a reference character.

The winding layers 4 respectively comprise a turn about a turning axis 5. The electrical conductor is configured strip-shaped and made of a superconducting material. The winding 3 is configured toroidally.

Between two winding layers 4 arranged adjacent to one another, a heat conductor 6 is arranged and is connected with at least one winding layer 4 in heat-exchanging manner. In addition, a heat conductor 6 is arranged on a first inner winding layer 4. In each case one section 7 of the heat conductors 6 projects out of the winding 3. In each case one cooling pipe 8 is arranged on the section 7 and is connected with the section 7 in a heat-exchanging manner.

Between the winding layers 4 adjacent to the heat conductors 6 and the heat conductors 6, in each case one electric insulating layer 9 of the heat conductor 6 is arranged. In addition, the winding layers 4 are electrically insulated relative to each other via electric insulating layers 10. Additionally, the cooling pipes 8 respectively comprise an electrically insulating section 11. Individual electric insulating layers 10 are exemplarily denoted with a reference character in the illustration.

The heat conductors 6 rest nearly completely on the respectively adjacently arranged winding layers 4. The heat conductors 6, however, each comprise an interruption section 12, in which the respective heat conductor 6 is completely interrupted so that no closed conductor loop is formed by the heat conductors 6 resting on the winding layers 4.

The winding sections respectively comprise contact points 13, in which the winding sections 2 can be connected amongst themselves and with an electrical supply device. In addition, the cooling pipes 8 respectively comprise connecting elements 14 for connection of the cooling pipes with a cooler.

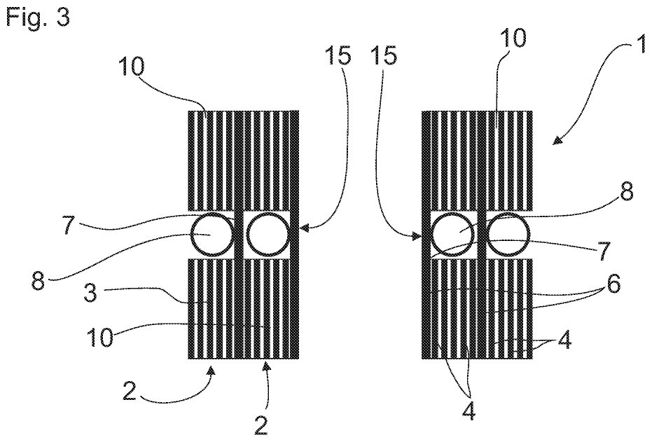

FIG. 3 schematically illustrates a sectional view of an alternatively configured machine coil 1. In the machine coil 1 illustrated in FIG. 3, the section 7 of the heat conductors 6 respectively projects into an intermediate region 15 between two windings 3 arranged distanced to one another. In this way, two windings 3 of the machine coil 1 can be cooled with the help of the heat conductors 6 and the cooling pipes 8 connectable with the cooler.

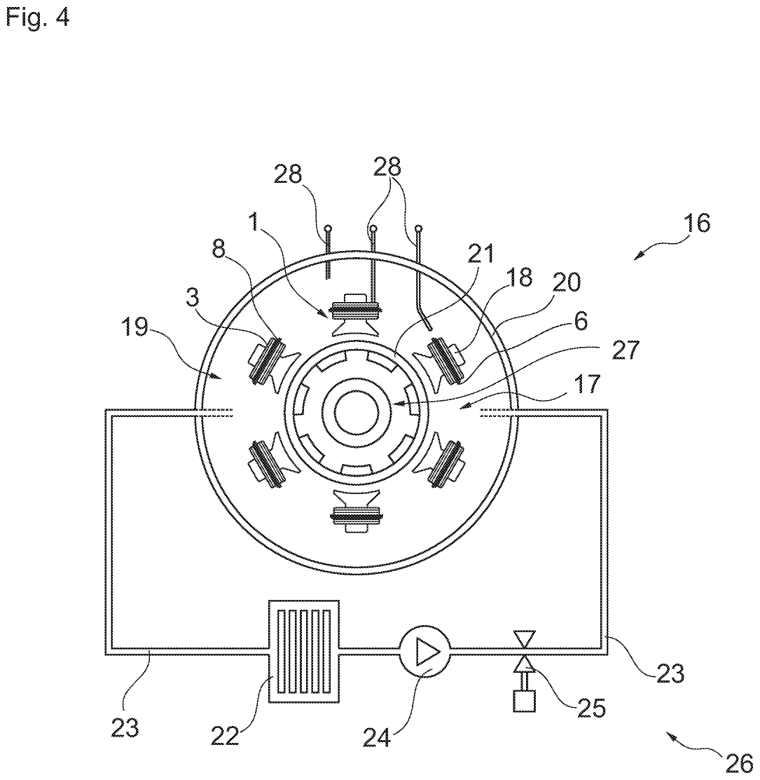

FIG. 4 shows a schematic illustration of an electric machine 16 with a stator 17, on which multiple machine coils 1 are arranged. Windings 3 of the machine coils 1 consist of a superconductive material. Between two winding layers of the windings 3, in each case one heat conductor 6 is arranged with a cooling pipe 8. The machine coils 1 further comprise coil cores 18.

The stator 17 is arranged inside a thermal insulator 19, which is formed by two cylindrical vacuum pipes 20, 21, arranged coaxially to one another, and vacuum pipe lids (not illustrated).

Respectively, only one machine coil 1, one winding 3, one heat conductor 6, one cooling pipe 8 and one coil core 18, is denoted with an assigned reference character in the drawing, for illustrative purposes.

The cooling pipes 8 are connected with a cryocooler 22 via pipelines 23, wherein feed lines from the pipelines 23 to the cooling pipes 8 are not represented and are indicated through the course illustrated in dashed lines. A cryogenic fluid is circulated inside this cooling circuit formed by the cooling pipes 8, the cryocooler 22, the pipelines 23, a coolant pump 24 and a regulating device 25, with the help of the coolant pump 24, inside this cooling circuit. The coolant through-flow rate is controlled with the regulating device 25. The cryocooler 22, the coolant pump 24, the pipelines 23, including the non-illustrated feed lines, and the regulating device 25 form a cooler 26.

A rotor 27 is located in the interior of the electric machine 1. The windings 3 of the machine coils 1 are supplied with a rotary current via electrical connections 28 by a frequency converter (not illustrated).

1.-13. (canceled)

14. A machine coil (1) for an electric machine (16),
wherein the machine coil (1) comprises at least one winding (3),
wherein the winding (3) comprises multiple winding layers (4) of an electrical conductor, the multiple winding layers (4) being arranged adjacent to one another and connected to one another in an electrically conducting manner,
wherein a heat conductor (6) is arranged between two of the multiple winding layers (4) and is connected with at least one winding layer (4) in a heat-exchanging manner,
wherein at least one section (7) of the heat conductor projects out of the winding (3), and
wherein a cooling pipe, connectable with a cooler (26), is arranged on the at least one section (7) and is connected with the at least one section (7) in a heat-exchanging manner.

15. The machine coil (1) according to claim 14, wherein the electrical conductor is produced of a superconductive electric material.

16. The machine coil (1) according to claim 14,
wherein the machine coil (1) comprises multiple heat conductors (6), and
wherein each of the multiple heat conductors (6) is arranged between two adjacent winding layers (4).

17. The machine coil (1) according to claim 16,
wherein the heat conductor (6) and the cooling pipe (8) are produced of a metallic material and
wherein the cooling pipe (8) is connected, at least in sections, with the heat conductor (6) through a solder connection.

18. The machine coil (1) according to claim 14,
wherein the heat conductor (6) comprises at least one electrically insulating layer (10) arranged between at least one winding layer (4) adjoining heat conductor (6) and the heat conductor (6).

19. The machine coil (1) according claim 14,
wherein the heat conductor (6) is connected with at least one winding layer (4) adjoining the heat conductor (6) in an electrically conductive manner.

20. The machine coil (1) according to claim 14,
wherein the cooling pipe (8) comprises an electrically insulating section (11) arranged distanced to the winding (3).

21. The machine coil (1) according to claim 14,
wherein the winding (3) is configured toroidally, and
wherein the winding (3) is produced of a strip-shaped electrical conductor material.

22. An electric machine (16), comprising:
a stator (17);
a rotor (27); and
multiple machine coils (1) as in claim 15,
wherein the windings (3) of the multiple machine coils (1) are arranged in a thermal insulator (19), and
wherein the electric machine (16) comprises a cooler (26) connected with the cooling pipe in a heat-conducting manner.

23. The electric machine (16) according to claim 22, wherein the thermal insulator (19) comprises regions in which a vacuum can be generated.

24. The electric machine (16) according to claim 22, wherein the thermal insulator (19) consists of a material which has a high electrical resistance.

25. The electrical machine (16) according to claim 22, wherein the cooler (26) comprises a cryocooler (22) or is flown through by a liquid or gaseous refrigerant in an open cooling circuit.
